(19) United States
(12) Patent Application Publication
(10) Pub. No.: US 2011/0252313 A1
(43) Pub. Date: Oct. 13, 2011

(54) DOCUMENT INFORMATION SELECTION METHOD AND COMPUTER PROGRAM PRODUCT

(76) Inventors: Ray Tanushree, Karnataka (IN); Madan Gopal Devadoss, Karnataka (IN); Shamik Majumdar, Karnataka (IN)

(21) Appl. No.: 13/139,549

(22) PCT Filed: Dec. 19, 2008
(86) PCT No.: PCT/IN08/00846

§ 371 Date: Jun. 14, 2011

(51) Int. Cl. G06F 17/27

(52) U.S. Cl. 715/255

(57) ABSTRACT

Disclosed is a method of generating an electronic document from a plurality of electronic documents, comprising providing a database comprising a plurality of electronic documents, each of said documents comprising semantically organized information portions; parsing the plurality of documents to extract semantic descriptors from said documents, each semantic descriptor relating to one of said information portions; displaying an overview of the extracted semantic descriptors for selection by a user; receiving user-selected extracted semantic descriptors; extracting the information portions relating to the user-selected semantic descriptors from the plurality of electronic documents; and combining said extracted portions into a further electronic document. The method may be implemented in a computer program product, which may form part of a data processing system.

### BACKGROUND OF THE INVENTION

The introduction of expansive computer systems such as large databases and the Internet has dramatically improved the easy accessibility of digital information. Nowadays, users of such systems have access to large amounts of information from a wide variety of different sources. However, this improvement is not without problems.

For instance, trying to find the correct information in such a digital information system can be a far from trivial task. Although it is possible to define queries to search such information systems, it is very difficult to define the query in such a way that the query yields only a few electronic documents that are all relevant to the defined search criteria. An electronic document may be a single file created with a word processing program such as MS Word, Acrobat, and so on, or may be the information that may be retrieved from a unique URL on the Internet.

Consequently, users of such information systems are more often than not confronted with the unenviable task of having to trawl through large numbers of electronic documents to find and retrieve the information of interest.

Many efforts have been made to provide users of such information systems with a more concise set of documents to consider as a result of a query to find information of interest, such as a search algorithm in which the relevance of an electronic document in respect of a search term is calculated from a combination of the number of occurrences of a particular term in the electronic document with a weighting factor retrieved from a so-called weighted-term dictionary. Unfortunately, this may still require the user to examine a large number of documents.

### BRIEF DESCRIPTION OF THE EMBODIMENTS

Embodiments of the invention are described in more detail and by way of non-limiting examples with reference to the accompanying drawings, wherein

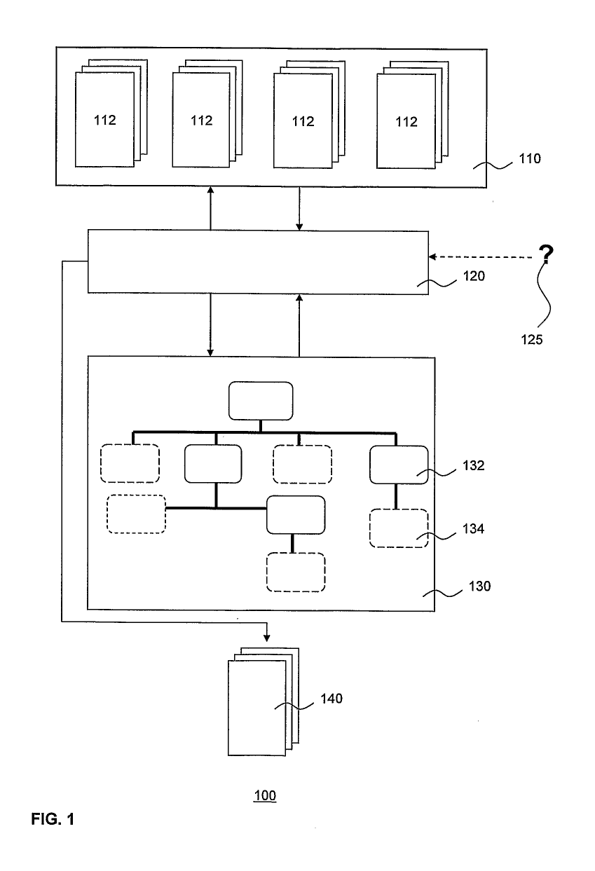

FIG. 1 schematically depicts the principle of an embodiment of the method of the present invention;

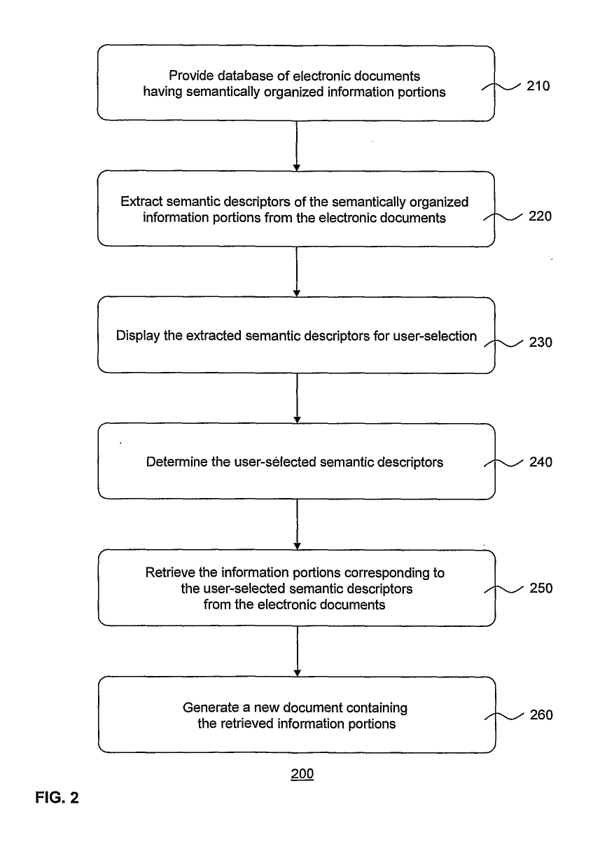

FIG. 2 schematically depicts a flowchart of an embodiment of the method of the present invention;

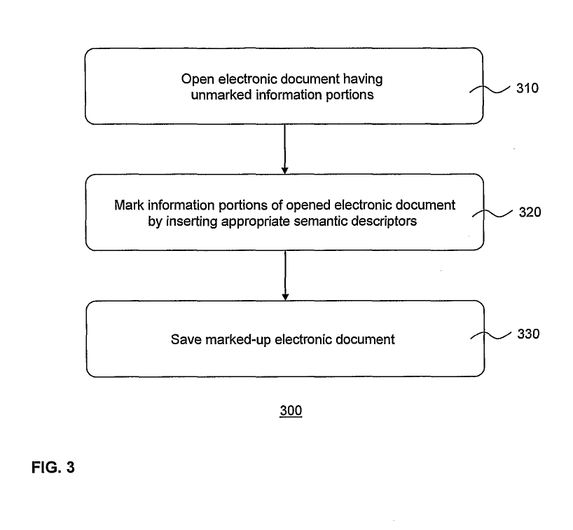

FIG. 3 schematically depicts a flowchart of an aspect of an embodiment of the method of the present invention; and

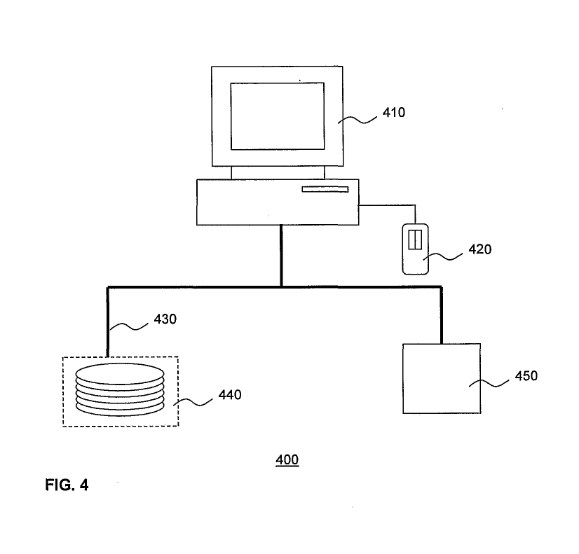

FIG. 4 schematically depicts a data processing system according to an embodiment of the present invention.

### DETAILED DESCRIPTION OF THE DRAWINGS

It should be understood that the Figures are merely schematic and are not drawn to scale. It should also be understood that the same reference numerals are used throughout the Figures to indicate the same or similar parts.

FIG. 1 provides a conceptual overview of an embodiment of a data processing system 100 of the present invention. In the overview 100, a database 110 of electronic documents 112 is available. The database 110 may be a proprietary database, the world-wide web (WWW) or any other suitable information resource. The electronic documents 112 each comprise semantically organized information portions. This semantic organization may be explicitly included, such as in the form of metadata that identifies the semantic context of the information portion. A non-limiting example of such metadata is given below:
Semantic SectionName
   SubSection 1
      Page
      Start Line
      End Line
   SubSection 2
      Page
      Start Line
      End Line
   SubSection 3
      Page
      Start Line
      End Line

In this example, the semantic section comprises a number of subsections to indicate that the semantic information may have a hierarchical structure. Obviously, in case of non-hierarchical semantic information, the semantic descriptor may for instance take the following form:
Semantic SectionName
   Page
   Start Line
   End Line

The electronic documents 112 may contain both hierarchical and non-hierarchical semantic descriptors, which may be recognized by any suitable parsing strategy. It should be appreciated that the electronic documents 112 may have the same or different formats, such as .txt, .doc, .pdf, .html, .xml files and so on. The semantic descriptors in the electronic documents 112 may be stored in an associated electronic document such as a header file using any suitable format. Known examples of such formats include Web Ontology Language, Resource Description Framework schema and the XML schema.

The data processing system 100 further comprises a semantic information processing layer 120, which is arranged to access the individual documents 112 in the database 110 upon a user of the data processing system 100 requesting information from the database 110. The semantic information processing layer 120 may include a software program product arranged to implement the method of the present invention, as will be explained in more detail later. The semantic information processing layer 120 is configured to extract the semantic descriptors from the electronic documents 112 and to display the extracted descriptors to the user of the data processing system 100 to allow the user to select the information portions of interest from the electronic documents 112.

In an embodiment, the extracted descriptors may be presented in the form of a list from which the user can select the information portions of interest. In another embodiment, the extracted semantic descriptors are presented in the form a tree 130, in which the leaves represent the semantic descriptors and the nodes between the leaves represent the hierarchical relationship between the semantic descriptors and/or the sequence of the semantic descriptor's in the electronic documents 112. The user may select leaves of interest, e.g. by pointing a cursor at the leaves of interest on the display and clicking a mouse button or some key on a keyboard. In FIG. 1, selected leaves have been labeled 132 and unselected leaves have been labeled 134.

In an embodiment, semantic descriptors occurring in multiple documents 112 comprising may be represented by single leaves in the tree 130. This has the advantage that a compact tree is provided that allows the user to quickly assess what information is available in the database 110. This is for instance particularly useful if the database 110 comprises multiple electronic documents 112 that share a semantic structure, such that the tree 130 will show a single branch for these documents.

In an embodiment, the user can indicate that selection of the information of interest has been completed, e.g. by providing the system 100 with an appropriate command, after which the information portions of interest are retrieved from the database 100 through the semantic information processing layer 120. A new electronic document 140 is generated into which the retrieved portions of interest 100 are stored, such that the user has all the information of interest available in a single electronic document. Alternatively, a number of electronic documents 140 may be generated if so requested by the user. It will be apparent that this approach has the distinct advantage that the user no longer has to access all of the electronic documents 112 to retrieve the information of interest to generate a personalized document, thus greatly reducing the amount of effort required from the user to collect the information of interest for this purpose.

In an embodiment, the user may place the information of interest in a preferred order, with the generated personalized electronic document 140 replicating this order. This order may for instance be defined by the user by selecting the leaves of the tree 130 corresponding to the information portions of interest in this order. Any suitable way of defining this order may be used.

In an embodiment, the personalized electronic document 140 is generated in a predefined format. In an alternative embodiment, the format of the personalized electronic document 140 is selected by the user. The personalized electronic document 140 may be generated in any suitable format. If the personalized electronic document 140 is to be added to the database 110, semantic descriptors may be added to the personalized electronic document 140 in any suitable form.

The method of the present invention is particularly suited for use in a data processing system 100 in which the database 110 comprises a limited number of electronic documents 112 that have some interrelation with each other, e.g. electronic documents comprised in a business database such as an Oracle database, in which all the documents typically relate to the business, such that the extraction of the semantic descriptors from the all the electronic documents is both feasible and potentially relevant.

The scale of the extraction task of the semantic information processing layer 120 may be reduced by the definition of a query 125 by the user. The query 125 may limit the semantic descriptor extraction task to certain types of electronic documents 112. For instance, in case of a database 110 comprising different classes of documents, the semantic descriptors may be extracted from electronic documents 112 from classes defined in the query 125. In an embodiment, the user may define a query 125 to limit the extraction task to certain types of semantic descriptors. For instance, in case of hierarchical semantic descriptors, the user may define a selection of top-level semantic descriptors of interest with the semantic information processing layer 120 extracting all the semantic descriptors depending from the defined top-level semantic descriptors. It is stipulated that many suitable queries 125 to reduce the volume of electronic documents 112 and/or the volume of semantic descriptors extracted from these documents will be apparent to the skilled person.

Although the method of the present invention is particularly suited for use in a data processing system 100 in which the database 110 comprises a limited number of electronic documents 112 that have some interrelation with each other, it is pointed out that this method is not limited to such types of databases. For instance, in case of the database content being largely unknown, as is for instance the case when the database comprises (parts of) the WWW, the semantic information processing layer 120 may be further arranged to limit the number of electronic documents 112 from which semantic descriptors are to be extracted in response to search criteria defined in the query 125. The selected electronic documents 112 may be further reduced by only considering those documents that have a relevance score exceeding a predefined threshold. Many solutions exist in the art to calculate such a relevance score, and any suitable method of calculating such a relevance score may be used.

Moreover, although it is preferred that descriptors are explicitly available for the electronic document of interest, it is pointed out that this is not essential. For instance, the semantic descriptors of interest may be defined in the query 125 after which the semantic information processing layer 120 is arranged to identify information portions in the selected electronic documents 112 that contain keywords related to the query-defined semantic descriptors. To this end, the semantic information processing layer 120 may comprise an electronic dictionary, thesaurus or like database to identify such information portions of interest. Such search algorithms are known per se, and any suitable search algorithm may be used for this purpose. In such a case, the boundaries of the information portion may, by way of non-limiting example, be defined by the beginning and end of a section or paragraph.

FIG. 2 shows a flowchart of an embodiment of the method 200 of the present invention. In step 210, the database 110 comprising the electronic documents 112 having semantically organized information portions is provided. In step 220, the semantic information processing layer 120 accesses the electronic documents 112 in the database 110 and extracts the semantic descriptors of the information portions from these documents. The semantic descriptors may be extracted from these documents using any suitable parsing strategy. Subsequently, as indicated in step 230, the semantic information processing layer 120 generates a list, e.g. a tree structure, as previously explained, of the extracted semantic descriptors to allow the user to select the corresponding information portions of interest. This list may for instance be displayed on a display device of the data processing system 100.

In step 240, the user-selected semantic descriptors are determined. As previously explained, this step may be triggered by the user indicating that the selection of the semantic descriptors of interest has been completed. In an embodiment, the order in which the semantic descriptors of interest have been selected is also determined. Next, the electronic documents 112 in the database 110 are accessed again by the semantic information processing layer 120, and the information portions corresponding to the user-selected semantic descriptors are extracted from these electronic documents, as indicated in step 250. The extracted information portions are compiled in one or more personalized electronic documents 140 generated by the semantic information processing layer 120 such that the user has access to the required information without having to trawl through the electronic documents 112 of the database 110. In an embodiment, the information portions are ordered in the one or more personalized electronic documents 140 in accordance with the order determined in step 240.

An example of an application of an embodiment of the method 200 of the present invention is given in the following use-case, in which an Oracle Database Administration 110 contains approximately 100 different electronic documents 112. These are semantically structured documents with mark-ups, i.e. semantic descriptors, for each section or information portion therein. The semantic information processing layer 120 reads through the semantic structure of each of these documents 112 and generates a common tree-like structure for the different pieces of information and their relationships. Some of the leaves in the tree structure may be independent leaves with no relation to other leaves. The user can select required pieces of information from the tree and order them as per requirement in the final document 140 to be generated.

For instance, the user may, select the following semantic descriptors from the information tree, and may order these descriptors in the following manner:
Oracle Database Administration
   Administration tools
Forms Developer
Oracle Enterprise Manager
   Application administration
   Back-up and Recovery
Incremental back-ups
Recovery Manager
   Indexing/Retrieval
Methods
Advantages

The semantic information processing layer 120 will subsequently extract the above selected information portions from all 100 different electronic documents 112 and create a generalized electronic document 140 comprising the selected information in the same order as specified by the user. The user may generate the final document in one or more formats like html, doc, pdf, text and so on. The user can apply different search templates or skins to the electronic documents 112 according to the user's choice and requirement.

FIG. 3 shows a flowchart an aspect of another embodiment of a method 300 of the present invention. The semantic information processing layer 120 may be arranged to execute a step 310, in which an electronic document without semantic descriptors is opened. In step 320, a programmer, e.g. a database manager, marks up the opened electronic document by inserting appropriate semantic descriptors into the opened document, such that the information portions in the marked up document may be accessed in accordance with the method as for instance shown in FIG. 2. After insertion of the semantic descriptors into the electronic document, the document is saved in step 330, e.g. into the database 110.

Hence, the method 300, when implemented in a software program product for execution on a computer processor, extends the software program product with an edit mode in which electronic documents that do not comprise semantically organized information may be converted into marked-up electronic documents, i.e. documents comprising such semantically organized information suitable for being accessed in accordance with the method shown in FIG. 2.

It will be appreciated that the various embodiments of the method of the present invention, such as the method shown in FIG. 2 and the method shown in FIG. 3 may be implemented in a computer program product for execution on a processor of a computer, which may belong to a data processing system 100 as shown in FIG. 1. The computer program product, when executed on the computer processor, is arranged to execute the steps of an embodiment of the method of the present invention, such as the method shown in FIG. 2. In effect, the computer program product implements the semantic information processing layer 120 of FIG. 1. The computer program product may be formed using any suitable algorithm. Implementation of an embodiment the method of the present invention into such a computer program product will be apparent to the skilled person, and will not be discussed in further detail for reasons of brevity only.

The computer program product in accordance with an embodiment of the present invention may be made available on any suitable computer-readable medium, such as a CD-ROM, DVD, portable memory device, or an Internet-accessible data source such as a software archive on an Internet server. Other suitable data storage means will be apparent to the skilled person.

FIG. 4 shows a data processing system 400 in accordance with an embodiment of the present invention. A computer 410 has a processor (not shown) and a control terminal 420 such as a mouse and/or a keyboard, and has access to a database 110 stored on a collection 440 of one or more storage devices, e.g. hard-disks or other suitable storage devices, and has access to a further data storage device 450, e.g. a RAM or ROM memory, a hard-disk, and so on, which comprises the computer program product implementing the semantic information processing layer 120. The processor of the computer 410 is suitable to execute the computer program product implementing the semantic information processing layer 120. The computer 410 may access the collection 440 of one or more storage devices and/or the further data storage device 450 in any suitable manner, e.g. through a network 430, which may be an intranet, the Internet, a peer-to-peer network or any other suitable network. In an embodiment, the further data storage device 450 is integrated in the computer 410.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method of generating an electronic document from a plurality of electronic documents, comprising:
providing a database comprising a plurality of electronic documents, each of said documents comprising semantically organized information portions;
parsing the plurality of documents to extract semantic descriptors from said documents, each semantic descriptor relating to one of said information portions;
displaying an overview of the extracted semantic descriptors for selection by a user;
receiving user-selected extracted semantic descriptors;
extracting the information portions relating to the user-selected semantic descriptors from the plurality of electronic documents; and
combining said extracted portions into a further electronic document.

2. The method of claim 1, wherein each document comprises an associated document comprising a plurality of semantic descriptors relating to respective information portions in said electronic document.

3. The method of claim 1, wherein said overview comprises a tree structure.

4. The method of claim 3, wherein semantic descriptors extracted from more than one electronic document are represented by a single leaf.

5. The method of claim 1, wherein said parsing step is preceded by defining a semantic query, and wherein said parsing step comprises extracting semantic descriptors from said electronic documents that match said query.

6. The method of claim 1, wherein the database comprises at least one unmarked electronic document, the method further comprising marking respective portions of information of the at least one unmarked electronic document by inserting semantic descriptors into said electronic document.

7. The method of claim 1, wherein the order of the portions of information in the further electronic document is based on the order in which their respective associated semantic descriptors are selected by the user.

8. A computer readable data storage medium storing a computer program product arranged to, when executed on a computer, execute the steps of:
accessing a database comprising a plurality of electronic documents, each of said documents comprising semantically organized information portions;
parsing the plurality of documents to extract semantic descriptors from said documents, each semantic descriptor relating to one of said information portions;
displaying, on a display connected to the computer, an overview of the extracted semantic descriptors for selection by a user;
receiving user-selected extracted semantic descriptors;
extracting the information portions relating to the user-selected semantic descriptors from the plurality of electronic documents; and
combining said extracted portions into a further electronic document.

9. The medium of claim 8, wherein each document comprises an associated document comprising the semantic descriptors.

10. The medium of claim 8, wherein said overview comprises a tree structure.

11. The medium of claim 10, wherein semantic descriptors extracted from more than one electronic document are represented by a single leaf.

12. The medium of claim 8, wherein said parsing step is preceded by defining a semantic query, and wherein said parsing step comprises parsing said electronic documents to extract semantic descriptors from said documents that match said query.

13. The medium of claim 8, wherein the database comprises at least one unmarked electronic document, the computer program product further being adapted to mark respective portions of information of the at least one unmarked electronic document by inserting semantic descriptors into said electronic document.

14. (canceled)

15. A data processing system comprising:
data storage configured to store a plurality of electronic documents comprising semantically organized information portions;
a computer program memory comprising a computer program product; and
a data processor having access the computer program memory and the data storage, the data processor being arranged to execute said computer program product;
wherein the a computer program product is arranged, when executed, to cause the data processor to execute the steps of:
accessing a database comprising a plurality of electronic documents, each of said documents comprising semantically organized information portions;
parsing the plurality of documents to extract semantic descriptors from said documents, each semantic descriptor relating to one of said information portions;
displaying, on a display connected to the computer, an overview of the extracted semantic descriptors for selection by a user;
receiving user-selected extracted semantic descriptors;
extracting the information portions relating to the user-selected semantic descriptors from the plurality of electronic documents; and
combining said extracted portions into a further electronic document.

16. The system of claim 15, wherein each document comprises an associated document comprising the semantic descriptors.

17. The system of claim 15, wherein said overview comprises a tree structure.

18. The system of claim 17, wherein semantic descriptors extracted from more than one electronic document are represented by a single leaf.

19. The system of claim 15, wherein said parsing step is preceded by defining a semantic query, and wherein said parsing step comprises parsing said electronic documents to extract semantic descriptors from said documents that match said query.

20. The system of claim 15, wherein the database comprises at least one unmarked electronic document, the computer program product further being adapted to mark respective portions of information of the at least one unmarked electronic document by inserting semantic descriptors into said electronic document.
